(19) United States
(12) Patent Application Publication
(10) Pub. No.: US 2011/0154291 A1
(43) Pub. Date: Jun. 23, 2011

(54) SYSTEM AND METHOD FOR FACILITATING FLOW DESIGN FOR MULTIMODAL COMMUNICATION APPLICATIONS

(75) Inventors: Roger Hoover, San Bruno, CA (US); Dorrian Porter, Menlo Park, CA (US); Huajun Qin, Fremont, CA (US); Irvin Remedios, San Francisco, CA (US)

(73) Assignee: MOZES INCORPORATED, Palo Alto, CA (US)

(21) Appl. No.: 12/643,133

(22) Filed: Dec. 21, 2009

(51) Int. Cl. G06F 9/44

(52) U.S. Cl. 717/120

(57) ABSTRACT

Methods, systems, and computer-readable storage media are disclosed that facilitate flow design for multimodal communication applications. Aspects for selecting, generating, and/or arranging application modules are described which include providing a graphical user interface (GUI) and receiving a user input via the GUI. The application modules are interchangeable within an interchangeable sequence of application modules based on the user input. The interchangeable sequence includes a first application module configured to receive data via a first communication channel, and a second application module configured to receive data via a second communication channel disparate from the first communication channel.

### TECHNICAL FIELD

The subject disclosure generally relates to multimodal communication applications, and more particularly to a flow design tool for generating and linking multimodal communication applications.

### BACKGROUND

With the rapidly increasing popularity and capabilities of wireless devices, people are becoming much more dependent on wireless devices as a means of receiving information than ever before. Much of this information is now accessible on such wireless devices via various disparate communication channels. For example, a user may utilize a wireless device to receive information via voice, SMS, MMS, and/or the internet.

Since people are receiving an increasing amount of information via such disparate communication channels, it is becoming increasingly desirable to develop an integrated approach for providing users with targeted content (e.g., promotional advertising campaigns). Namely, it is becoming increasingly desirable to utilize multimodal communication applications to implement promotional campaigns. For instance, different stages of a promotional campaign may be more effective and/or user-friendly if performed via particular communication channels. For example, since users are generally more accessible via SMS than via e-mail, it may be more effective to send an initial advertisement via SMS. On the other hand, the act of purchasing the product advertised via the SMS message may be more user-friendly if performed via a website than via SMS.

Conventional systems, however, do not provide an adequate mechanism for linking disparate communication applications. Indeed, in order to link disparate communication applications, flow design developers must manipulate/add code to the existing applications to make them compatible. Current methods for linking disparate communication applications are thus inefficiently expensive and time-consuming. Accordingly, it would be desirable to provide a flow design tool for seamlessly generating and linking multimodal communication applications.

The above-described deficiencies of the current state of the art are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various non-limiting embodiments, aspects for facilitating flow design for multimodal communication applications are described. In a first embodiment, a method for facilitating such flow design is described. Within such embodiment, a processor is employed to execute computer executable instructions stored on a computer readable storage medium to implement a series of steps. The series of steps includes receiving a user input and generating each of a first application module and a second application module based on the user input. Within such embodiment, the first application module receives a first data via a first communication channel, whereas the second application module receives a second data via a second communication channel disparate from the first communication channel. The series of steps also includes interchanging the first application module with the second application module within an interchangeable sequence of application modules based on the user input.

In another embodiment, a computer-readable storage medium that facilitates flow design for multimodal communication applications is described. Within such embodiment, the computer-readable storage medium stores computer-readable instructions including instructions that when executed by at least one processor cause the at least one processor to perform a series of acts. The series of acts includes receiving a user input and generating each of a first application module and a second application module based on the user input. Within such embodiment, the first application module receives a first data via a first communication channel, whereas the second application module receives a second data via a second communication channel disparate from the first communication channel. The series of acts also includes executing an interchangeable sequence of application modules based on the user input, wherein the interchangeable sequence includes the first application module and the second application module.

In yet another embodiment, a system that facilitates flow design for multimodal communication applications is described, which includes a processor configured to execute computer executable components stored in memory. Within such embodiment, the computer executable components include a graphical user interface (GUI) component, an application component, and a sequence component. The GUI component is configured to receive a user input, whereas the application component is configured to facilitate providing access to at least a first application module and a second application module based on the user input. For this embodiment, the first application module is configured to receive data via a first communication channel, and the second application module is configured to receive data via a second communication channel disparate from the first communication channel. Furthermore, the sequence component is configured to facilitate arranging an interchangeable sequence of application modules based on the user input in which the interchangeable sequence of application modules includes the first application module and the second application module.

These and other embodiments are described in more detail below.

### BRIEF DESCRIPTION OF THE DRAWINGS

Various non-limiting embodiments are further described with reference to the accompanying drawings in which:

FIG. 1 is a diagram illustrating an exemplary interchangeable sequence of application modules in accordance with an embodiment;

FIG. 2 illustrates a block diagram of an exemplary flow tool device that facilitates flow design for multimodal communication applications in accordance with an aspect of the subject specification;

FIG. 3 is an illustration of a first exemplary coupling of electrical components that facilitates flow design for multimodal communication applications;

FIG. 4 is a diagram illustrating an exemplary application module in accordance with an embodiment;

FIG. 5 is a diagram illustrating an exemplary GUI for generating an application module in accordance with an embodiment;

FIG. 6 is a flow chart illustrating an exemplary methodology that facilitates executing an application module in accordance with an embodiment;

FIG. 7 is an illustration of a second exemplary coupling of electrical components that facilitates flow design for multimodal communication applications;

FIG. 8 is a diagram illustrating an exemplary GUI for generating an application module sequence in accordance with an embodiment;

FIG. 9 is a diagram illustrating an application module sequence including an exemplary logical operation in accordance with an embodiment;

FIG. 10 is a flow chart illustrating an exemplary methodology that facilitates executing the application module sequence illustrated in FIG. 9;

FIG. 11 is a block diagram representing exemplary non-limiting networked environments in which various embodiments described herein can be implemented; and

FIG. 12 is a block diagram representing an exemplary non-limiting computing system or operating environment in which one or more aspects of various embodiments described herein can be implemented.

### DETAILED DESCRIPTION

The subject specification discloses various embodiments directed towards facilitating multimodal flow design via interchangeable communication application modules. As discussed in the background, conventional flow design tools do not provide a mechanism for efficiently linking communication applications corresponding to disparate communication channels. The subject specification overcomes this limitation by providing a flow design tool for generating application modules corresponding to disparate communication channels, wherein such application modules are interchangeable within an interchangeable sequence of application modules. Namely, a design tool is provided that enables a flow designer to seamlessly rearrange a sequence of multimodal application modules without having to add/manipulate code.

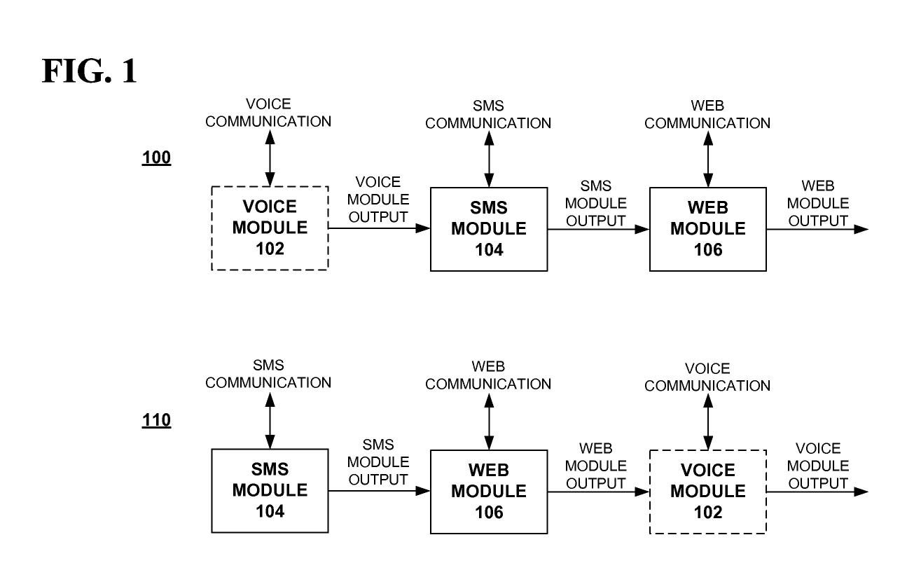

Referring next to FIG. 1, a diagram illustrating an exemplary interchangeable sequence of application modules in accordance with an embodiment is provided. For this particular example, a hypothetical promotional campaign scenario is contemplated, wherein such promotional campaign is implementable via either sequence 100 or 110. Within the context of a promotional campaign for a musical concert, for example, variants of the promotional campaign are implementable via different combinations of voice module 102, SMS module 104, and/or Web module 106, wherein each of modules 102, 104, and 106, respectively communicate with a promotional participant via a disparate communication channel. For instance, voice module 102 may include code for facilitating voice communications with participants (e.g., code for processing a voice response from participants wanting to join a mobile list for a band performing in the concert). SMS module 104, on the other hand, may include code for facilitating SMS communications with participants (e.g., code for sending participants a discount code for tickets to the concert via SMS), whereas Web module 106 may include code for facilitating Web communications with participants (e.g., code for sending an e-mail offer for a concert T-Shirt).

Depending on the particular promotional goals of the concert promoters, a flow designer may thus utilize any combination of application modules 102, 104, and/or 106. For instance, in a first scenario (e.g., many weeks before the concert), a concert promoter may wish to begin the promotional campaign by soliciting participants to join a mobile list for a particular band via a voice communication (e.g., where phone calls received from participants trigger voice module 102). For this scenario, a flow designer may thus design sequence variation 100, which begins with voice module 102, followed by SMS module 104 and Web module 106, as illustrated. However, in a second scenario (e.g., days before the concert), a concert promoter may wish to begin the promotional campaign by sending participants a discount code for tickets to the concert via SMS (e.g., by executing SMS module 104 which sends the discount code to participants via SMS). For this second scenario, a flow designer may thus re-arrange sequence variation 100 to yield sequence variation 110, which begin with SMS module 104, followed by Web module 106, and subsequently followed by voice module 102, as illustrated.

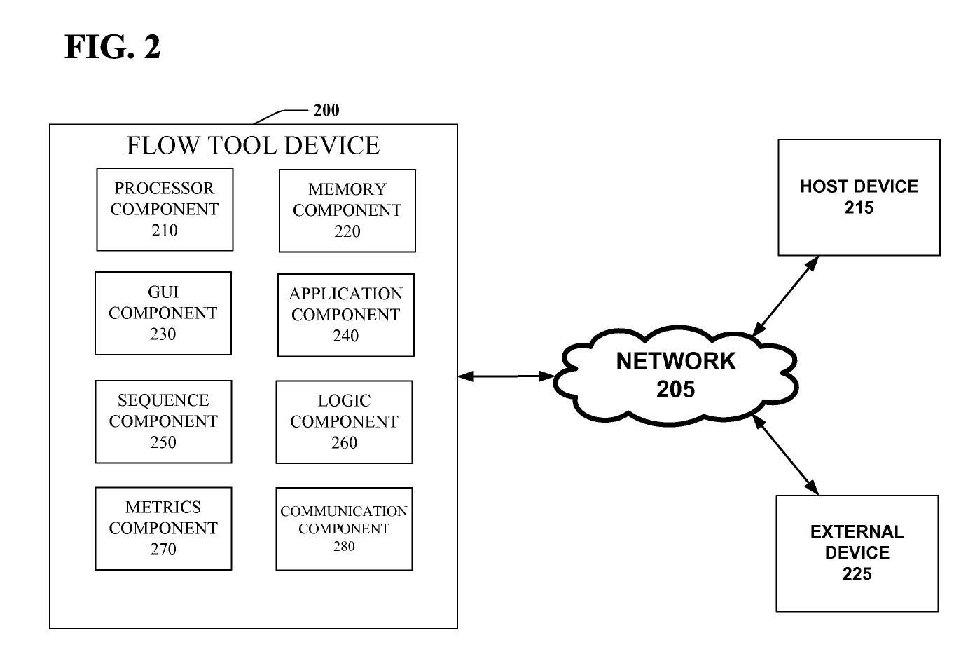

Referring next to FIG. 2, a block diagram of an exemplary flow tool device that facilitates flow design for multimodal communication applications is provided. As shown, flow tool device 200 may include processor component 210, memory component 220, GUI component 230, application component 240, sequence component 250, logic component 260, metrics component 270, and communication component 280.

In one aspect, processor component 210 is configured to execute computer-readable instructions related to performing any of a plurality of functions. Processor component 210 can be a single processor or a plurality of processors dedicated to analyzing information to be communicated from wireless terminal 200 and/or generating information that can be utilized by memory component 220, GUI component 230, application component 240, sequence component 250, logic component 260, metrics component 270, and/or communication component 280. Additionally or alternatively, processor component 210 may be configured to control one or more components of flow tool device 200.

In another aspect, memory component 220 is coupled to processor component 210 and configured to store computer-readable instructions executed by processor component 210. Memory component 220 may also be configured to store any of a plurality of other types of data including data received via communication component 280, as well as data generated by any of GUI component 230, application component 240, sequence component 250, logic component 260, metrics component 270, and/or communication component 280. Memory component 220 can be configured in a number of different configurations, including as random access memory, battery-backed memory, hard disk, magnetic tape, etc. Various features can also be implemented upon memory component 220, such as compression and automatic back up (e.g., use of a Redundant Array of Independent Drives configuration).

In yet another aspect, GUI component 230 is configured to receive a user input. Here, it should be appreciated that GUI component 230 may be configured to receive any of various types of inputs to perform any of a plurality of functions. For instance, in an exemplary embodiment, GUI component 230 is configured to receive a user input for generating and/or executing a particular application module and/or a sequence of application modules. It should be further appreciated that GUI component 230 may be configured to provide a user with any of a plurality of types of GUIs. For instance, in a first embodiment, a GUI may include text fields for implementing various aspects of a flow design (e.g., text fields for entering strings identifying various aspects of an application module). In another embodiment, however, a GUI may facilitate flow design by providing users with a set of selectable icons (e.g., icons representing various application modules that can be dragged/dropped into different positions in a sequence of application modules).

As illustrated, flow tool device 200 may also include application component 240. Within such embodiment, application component 240 may be configured to facilitate providing access to application modules via network 205 based on a user input. For instance, in a first embodiment, application component 240 may be configured to provide access to existing application modules stored in either host device 215 or external device 225. In another embodiment, application component 240 may be configured to facilitate generating new application modules based on the user input. It should be further appreciated that, once an application module has been retrieved/generated, such application module is ultimately executable via network 205 (e.g., on host device 215 and/or external device 225). Within such embodiment, an output generated by executing the retrieved/generated application module may then be utilized by flow tool device 200 in various ways. For instance, flow tool device 200 may include logic component 260, wherein logic component 260 is configured to direct host device 215 to select a particular destination from a plurality of potential destinations to transmit such an output. In another aspect, flow tool device 200 includes a metrics component 270 configured to direct host device 215 to track metrics corresponding to the execution of the retrieved/generated application module.

In another aspect, flow tool device 200 also includes sequence component 250, which is configured to facilitate arranging an interchangeable sequence of interchangeable application modules based on a user input. Within such embodiment, a user may utilize a GUI provided by GUI component 230 to determine a particular arrangement of a set of application modules. For example, an interchangeable sequence may include a first application module configured to receive data via an SMS channel, and a second application module configured to receive data via a voice channel, wherein the first application module may reside either before or after the second application module.

In another aspect, flow tool device 200 also includes communication component 280, which is configured to facilitate communications with external entities. For example, communication component 280 may include a network interface to facilitate communications with devices accessible via network 205 (e.g., host device 215 and/or external device 225). Indeed, in an aspect, flow tool device 200 communicates with host device 215 and simply directs host device 215 to retrieve and/or generate particular application modules. Within such embodiment, since different application modules may receive data from disparate communication channels (e.g., a first application module configured to receive data via an SMS channel, and a second application module configured to receive data via a voice channel), host device 215 is configured to facilitate communications via various communication channels. For example, in embodiments where a single application module is executed, host device 215 may be configured to exchange data via the particular communication channel(s) corresponding to the application module. For instance, for an application module that processes SMS messages, host device 215 may be configured to exchange SMS messages with an external entity. In another example, where a sequence of application modules is executed, host device 215 is configured to exchange data via the communication channels respectively corresponding to each application module of the sequence. For instance, for a sequence that includes a first application module that processes SMS messages and a second application module that processes Web messages, host device 215 may be configured to exchange SMS messages and Web messages with external entities. In further aspects, host device 215 may also be configured to communicate with other external entities including, for example, an external profile database (i.e., a database that stores preferences corresponding to particular customers/members) and/or an external application module database (i.e., a database that stores existing application modules).

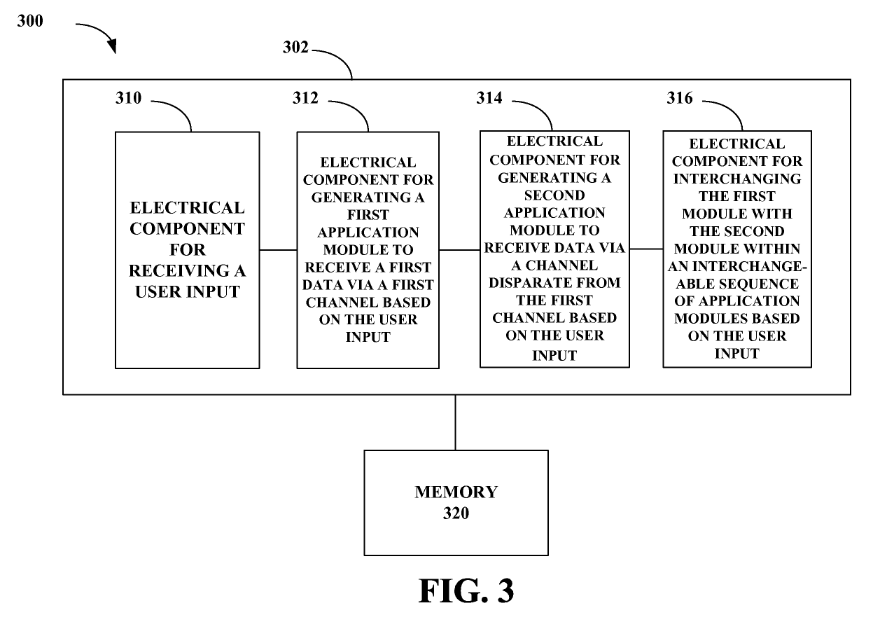

Turning to FIG. 3, illustrated is a system 300 that facilitates flow design for multimodal communication applications. System 300 and/or instructions for implementing system 300 can physically reside within a computing device or computer-readable storage medium, for instance. As depicted, system 300 includes functional blocks that can represent functions implemented by a processor, software, or combination thereof (e.g., firmware). System 300 includes a logical grouping 302 of electrical components that can act in conjunction. As illustrated, logical grouping 302 can include an electrical component for receiving a user input 310. Further, logical grouping 302 can include an electrical component for generating a first application module to receive a first data via a first communication channel based on the user input 312, as well as an electrical component for generating a second application module to receive a second data via a second communication channel disparate from the first communication channel based on the user input 314. Logical grouping 302 can also include an electrical component for interchanging the first application module with the second application module within an interchangeable sequence of application modules based on the user input 316. Additionally, system 300 can include a memory 320 that retains instructions for executing functions associated with electrical components 310, 312, 314, and 316. While shown as being external to memory 320, it is to be understood that electrical components 310, 312, 314, and 316 can exist within memory 320.

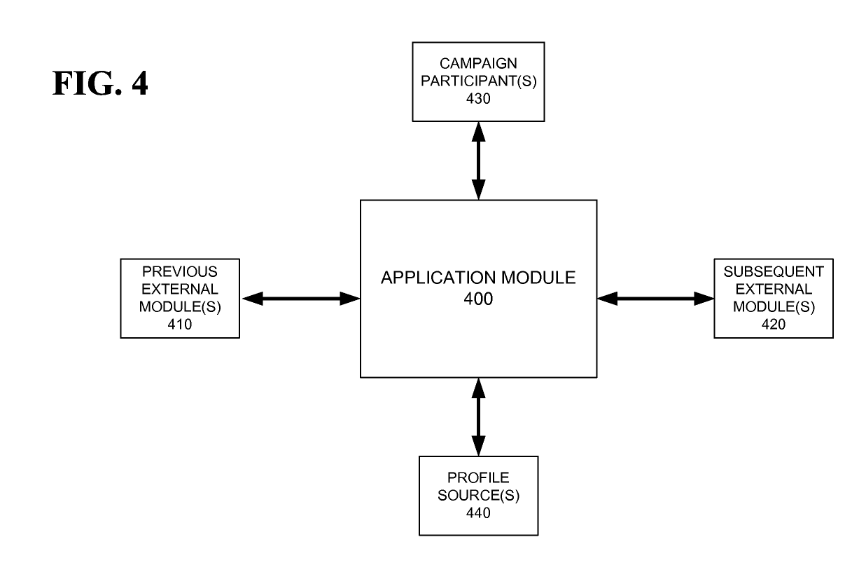

Referring next to FIG. 4, a diagram illustrating an exemplary application module in accordance with an embodiment is provided. As illustrated, application module 400 may be configured to communicate with any combination of previous application module(s) 410, subsequent application module(s) 420, campaign participant(s) 430, and/or profile source(s) 440.

Within such embodiment, application module 400 may reside in any of a plurality of sequential positions relative to previous application module(s) 410 and subsequent application module(s) 420. For instance, in an aspect, application module 400 is executable with or without a particular input from previous application module(s) 410. To implement such embodiment, application module 410 may be configured to include code that provides alternative execution schemes depending on whether an input from a particular application module is received. For example, a simple “if-then” statement may be used in which a first execution scheme is utilized if data is received from Application Module X (e.g., when Application Module X is executed before application module 400), whereas a second execution scheme is utilized if no such data is received (e.g., when Application Module X is executed after application module 400).

In a related aspect, application module 400 is executable regardless of the presence of subsequent application module(s) 420. For instance, in a first embodiment, application module 400 utilizes the same execution scheme, regardless of which particular subsequent application module(s) 420 is/are present, if any. In a second embodiment, however, application module 400 may vary its execution scheme as a function of subsequent application module(s) 420. Here, a simple “if-then” statement may again be used in which a first execution scheme is utilized if application module 400 receives an indication that subsequent application module(s) 420 includes Application Module Y. Otherwise, a second execution scheme is utilized if no such indication is received.

In another aspect, application module 400 may be configured to communicate with campaign participant(s) 430. Within such embodiment, code within application module 400 may determine the extent of such communication, as well as the particular communication channel in which the communication will take place. For instance, application module 400 may be configured to facilitate sending a particular SMS message to campaign participant(s) 430.

Here, it should be noted that the particular SMS message sent to campaign participant(s) 430 may vary depending on any combination of factors. For instance, the SMS message may vary depending on an input received from previous application module(s) 410 (e.g., whether a previous voice module indicates that campaign participant(s) 430 provided a correct answer to a trivia question) and/or campaign participant(s) 430 (e.g., whether campaign participant(s) 430 provides a correct personal identification number via SMS).

The execution of application module 400 may also vary depending on particular profiles obtained from profile source(s) 440, wherein such profiles store particular preferences associated with the promotional campaign itself and/or campaign participant(s) 430. For instance, a profile associated with the promotional campaign may dictate that a particular SMS message be sent prior to a certain date, whereas a different SMS message should be sent after the certain date. On the other hand, a profile associated with a particular campaign participant may indicate that the participant prefers to receive SMS messages only during certain hours of the day, wherein the campaign participant may instead receive an e-mail message during those hours. It should be further appreciated that profile source(s) 440 may reside in any of a plurality of locations including, for example, within an internal system (e.g., within an internal profile database) and/or an external system maintained by an external entity (e.g., a wireless carrier, external website/database, etc.).

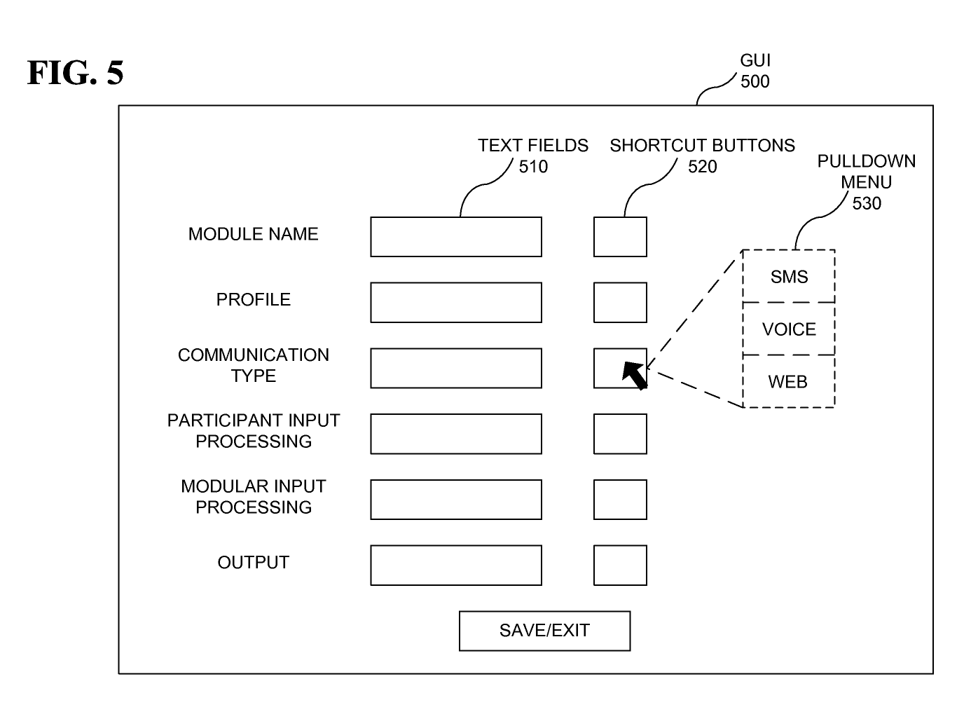

To facilitate generating application modules, such as application module 400, any of various types of GUIs may be utilized. Referring next to FIG. 5, a diagram illustrating an exemplary GUI for generating an application module in accordance with an embodiment is provided. For this particular embodiment, GUI 500 includes a plurality of text fields 510 for entering various aspects of an application module. Here, it should be noted text fields 510 may be configured to receive text in various formats including text corresponding to particular keywords, text identifying particular storage locations, and the like. For instance, when retrieving a particular application module, a user may identify such module by typing the module's name (e.g., “Module Foo”) and/or location (e.g., “/root/directoryX/foo”) in the “MODULE NAME” field. In an aspect, upon retrieving a particular module, each of text fields 510 are filled automatically according to the previously saved characteristics of the retrieved module. In another aspect, to expedite retrieving a particular module, the “MODULE NAME” field can be configured to include an auto-text feature to automatically infer the module desired by the user. In another yet another aspect, GUI 500 also includes shortcut buttons 520, which display pull-down menus 530, as illustrated.

In addition to a “MODULE NAME” field, text fields 510 may further include fields for entering other application module characteristics. For example, as illustrated, text fields 510 may further include a “PROFILE” field (e.g., indicating that execution of the application module depends on preferences stored in a particular profile database), a “COMMUNICATION TYPE” field (e.g., indicating the type of communication channel for communicating with a campaign participant), a “PARTICIPANT INPUT PROCESSING” field (e.g., indicating a location of an algorithm for processing data received from participants), a “MODULAR INPUT PROCESSING” field (e.g., indicating a location of an algorithm for processing data received from external application modules), and an “OUTPUT” field (e.g., indicating where to send an output generated by the application module).

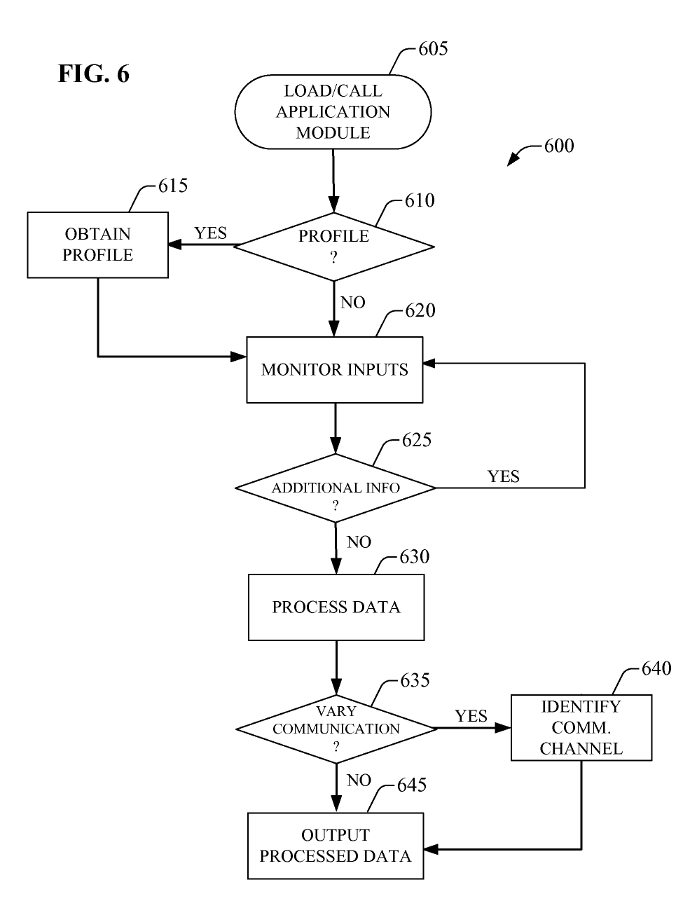

Referring next to FIG. 6, a flow chart illustrating an exemplary methodology that facilitates executing an application module is provided. As illustrated, process 600 includes a series of steps that may be performed by a computing device such as flow tool device 200. For instance, process 600 may be implemented by employing a processor to execute computer executable instructions stored on a computer readable storage medium to implement the series of steps. In another embodiment, a computer-readable storage medium comprising code for implementing the steps of process 600 is contemplated.

In an aspect, process 600 begins by loading a particular application module at step 605. Next, at step 610, process 600 determines whether the loaded application module includes a call to a particular profile database. If a profile database is indeed called, process 600 proceeds by obtaining the appropriate profile at step 615 and subsequently proceeding to step 620. Otherwise, if a profile is not needed, process 600 proceeds directly to step 620.

At step 620, process 600 monitors the particular inputs received by flow tool device 200. As stated previously, such inputs may vary depending on various factors including the position of the application module relative to other application modules. Accordingly, depending on the particular execution algorithm embedded within the application module, process 600 continues by determining, at step 625, whether additional data is needed before further execution may continue. For example, if a password authentication is required, such authentication may be provided either directly from the campaign participant and/or a previous application module. Therefore, if a password authentication is not provided by a previous application module, process 600 may simply loop back to step 620 and wait for the participant to provide a valid password. Otherwise, if a password authentication is indeed provided by a previous application module, process 600 may proceed to step 630.

At step 630, process 600 continues by processing data according to the execution scheme embedded in the application module. Here, it should again be noted that the particular execution scheme executed by process 600 may vary depending on the particular inputs received. Furthermore, it should be appreciated that, while some data may be processed, other data may simply be passed to subsequent application modules without further processing (e.g., a password authentication indicator).

Next, at step 635, process 600 continues by determining whether to configure a different communication channel with a participant. For instance, in an exemplary scenario, a participant may receive a coupon via e-mail for a particular item depending on whether the participant correctly answered a trivia question via SMS. Accordingly, for such scenario, if the participant correctly answers the trivia question, process 600 proceeds by retrieving the participant's e-mail address at step 640, wherein the coupon is subsequently e-mailed at step 645. Otherwise, process 600 proceeds directly to step 645, wherein the participant is notified via SMS that the trivia question was answered incorrectly.

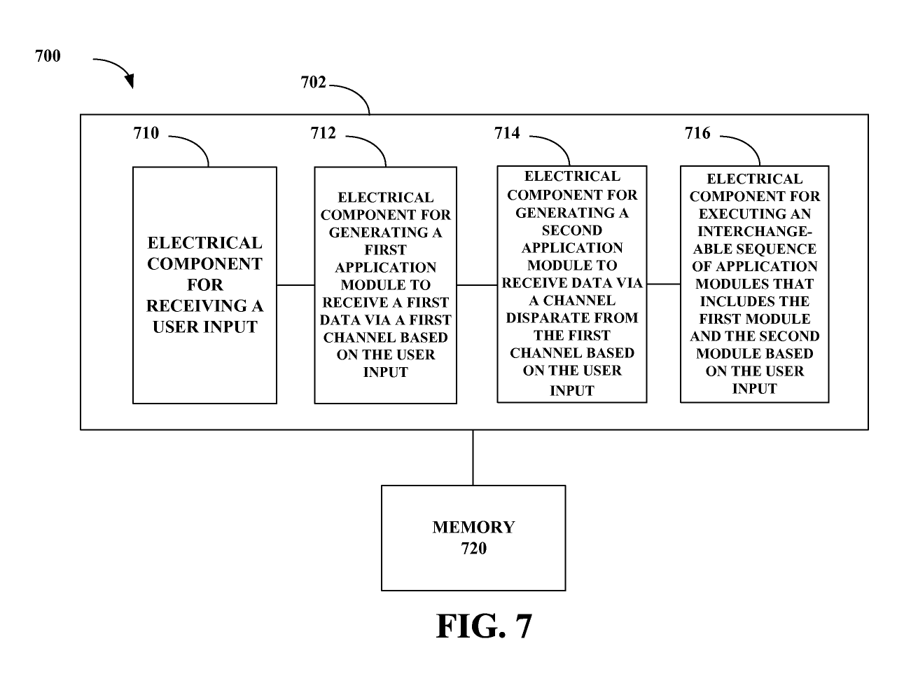

As mentioned previously, novel aspects described herein may also be implemented to generate sequences of multimodal communication applications. Referring next to FIG. 7, illustrated is a system 700 that facilitates flow design for such multimodal communication application sequences. System 700 and/or instructions for implementing system 700 can physically reside within a computing device or computer-readable storage medium, for instance, wherein system 700 includes functional blocks that can represent functions implemented by a processor, software, or combination thereof (e.g., firmware). Moreover, system 700 includes a logical grouping 702 of electrical components that can act in conjunction similar to logical grouping 302 in system 300. As illustrated, logical grouping 702 can include an electrical component for receiving a user input 710. Further, logical grouping 702 can include an electrical component for generating a first application module to receive a first data via a first communication channel based on the user input 712, as well as an electrical component for generating a second application module to receive a second data via a second communication channel disparate from the first communication channel based on the user input 714. Logical grouping 702 can also include an electrical component for executing an interchangeable sequence of application modules that includes the first application module and the second application module based on the user input 716. Additionally, system 700 can include a memory 720 that retains instructions for executing functions associated with electrical components 710, 712, 714, and 716. While shown as being external to memory 720, it is to be understood that electrical components 710, 712, 714, and 716 can exist within memory 720.

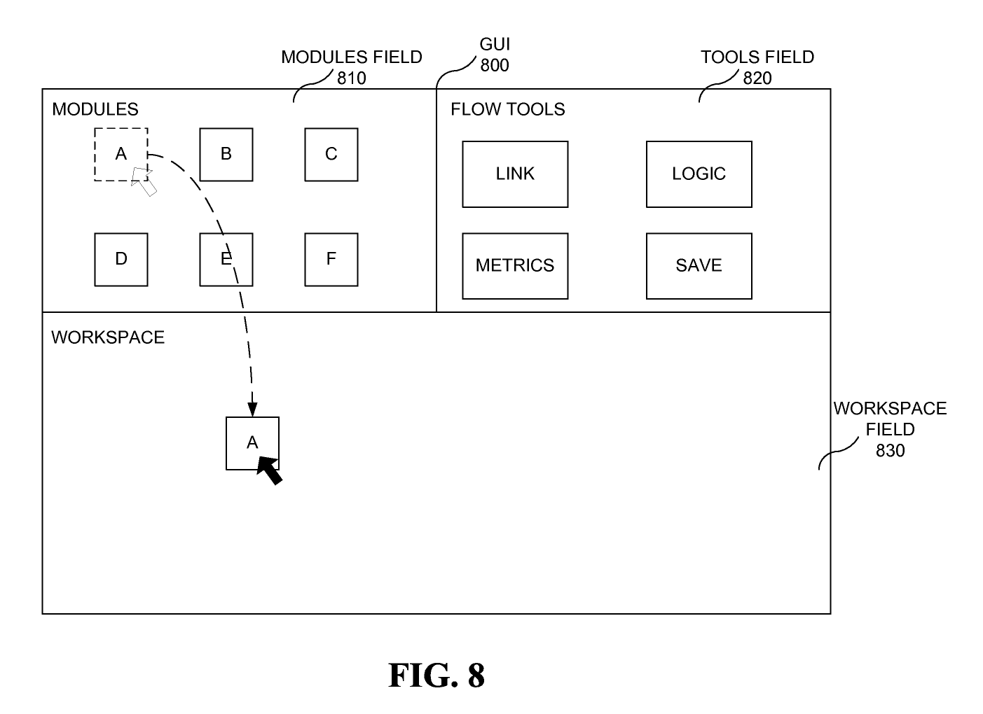

Referring next to FIG. 8, a diagram illustrating an exemplary GUI for generating a sequence of multimodal communication applications in accordance with an embodiment is provided. Here, rather than utilizing a text-based GUI (such as GUI 500 described in FIG. 5), an icon-based GUI 800 is provided. Nevertheless, it should be appreciated that either of GUI 500 or GUI 800 are implementable as GUIs that are either icon-based, text-based, and/or any combination of other types of GUIs known in the art.

As illustrated in FIG. 8, GUI 800 includes a modules field 810, tools field 820, and workspace field 830. Within such embodiment, modules field 810 is configured to display a plurality of icons representing various application modules accessible via GUI 800. In an aspect, application modules displayed within modules field 810 may include application modules stored internally and/or externally, wherein such application modules are selectable by a user. For instance, a user may drag/drop icons representing desired application modules into workspace field 830.

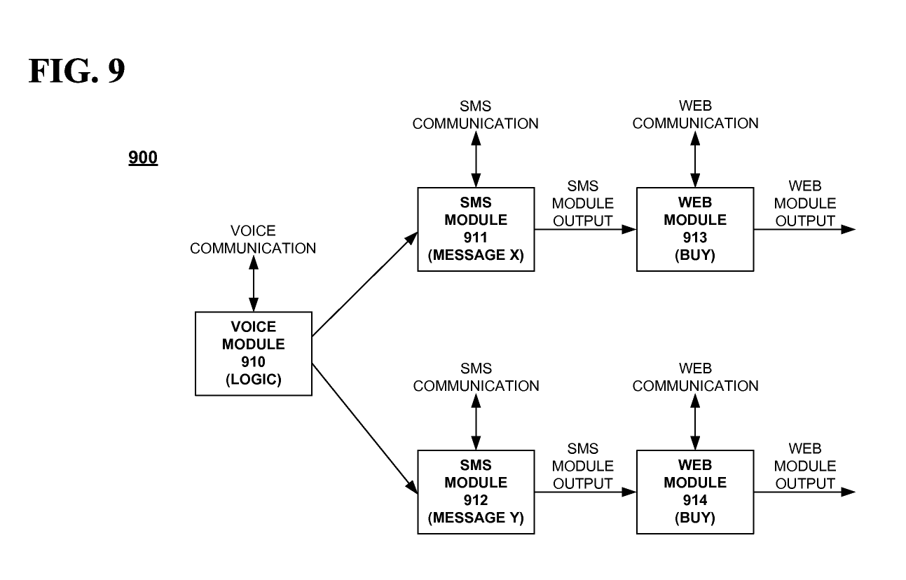

Once a user has dragged/dropped application modules into workspace field 830, the user may then customize a desired sequence of those application modules by utilizing the various tools displayed in tools field 820. For instance, a user may link two application modules by highlighting the two application modules within workspace field 830, and subsequently selecting the “link” button in tools field 820. In another aspect, a user may further customize the sequence by inserting metrics operators (e.g., to track metrics corresponding to a particular application module and/or application module sequence) and/or logic operators (e.g., to indicate that the sequence should proceed to a particular application module as in the sequence described in FIG. 9 below).

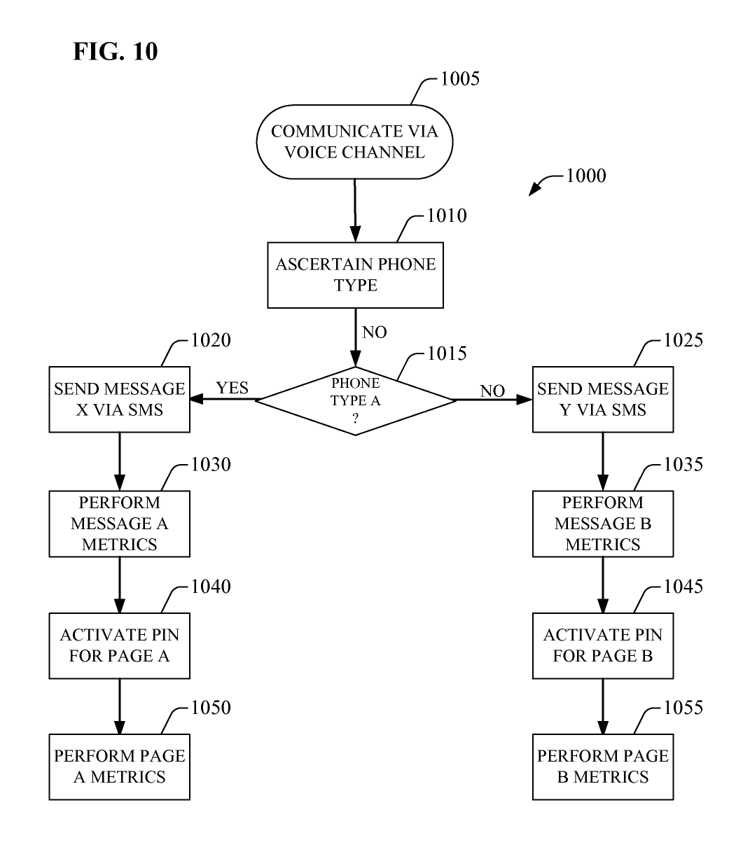

Referring next to FIG. 9, illustrated is a diagram of an application module sequence including an exemplary logical operation in accordance with an embodiment. As illustrated, sequence 900 forks into two directions depending on the outcome of a particular logic operation performed by voice module 910. For this particular embodiment, a scenario is contemplated in which voice module 910 performs a logical operation based on the type of phone utilized by the campaign participant. In FIG. 10, a flow chart illustrating an exemplary methodology that facilitates executing the application module sequence 900 illustrated in FIG. 9 is provided.

As illustrated, process 1000 begins with voice module 910 receiving a voice communication from a participant at step 1005. At step 1010, voice module 910 then determines the type of phone utilized by the participant, wherein such determination can be made in any of various ways. For instance, in a first embodiment, the type of phone may be identified in the participant's profile (e.g., a profile stored internally and/or provided by the participant's wireless carrier). In another embodiment, the participant may simply be asked to identify the type of phone his/her is using.

Next, at step 1015, voice module 910 determines whether the participant is utilizing a particular phone type (e.g., phone type “A”). If the participant is indeed using a type “A” phone, voice module 910 initiates the execution of SMS module 911 at step 1020. At step 1020, SMS module 911 sends “Message X” to the participant via SMS, wherein Message X may be a custom message directed towards users of type “A” phones (e.g., a message including an attachment supported by type “A” phones). In an aspect, SMS module 911 is configured to include a metrics component, which tracks the number of type “A” phones triggering SMS module 911 at step 1030.

In an exemplary embodiment, Message X may provide a personal identification number (PIN) for the participant to redeem a coupon at a particular website. Within such embodiment, process 1000 continues to step 1040 where an output generated by SMS module 911 initiates the execution of Web module 913. For instance, at step 1040, Web module 913 may activate the PIN sent via Message X. At step 1050, Web module 913 may then perform metrics to determine how many users of type “A” phones made purchases with their respective PINs.

Similarly, if at step 1015, voice module determines that the participant is not using a type “A” phone, process 1000 proceeds by executing SMS module 912 and Web module 914, which are provide outputs for non-users of type “A” phones. Specifically, if a non-type “A” phone is identified, voice module 910 initiates the execution of SMS module 912 at step 1025. At step 1025, SMS module 912 sends “Message Y” to the participant via SMS, wherein Message Y may be a custom message directed towards users of non-type “A” phones (e.g., a message excluding the attachment supported by type “A” phones and including a PIN similar to the PIN sent in Message X). Similar to SMS module 911, SMS module 912 may be configured to include a metrics component, which tracks the number of non-type “A” phones triggering SMS module 912 at step 1035. Within such embodiment, process 1000 may then continue to step 1045 where an output generated by SMS module 912 initiates the execution of Web module 914. For instance, at step 1045, Web module 914 may activate a PIN sent via Message Y. At step 1055, Web module 914 may then perform metrics to determine how many users of non-type “A” phones made purchases with their respective PINs.

### Exemplary Networked And Distributed Environments

One of ordinary skill in the art can appreciate that the various embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may be used to implement the various embodiments of the subject disclosure.

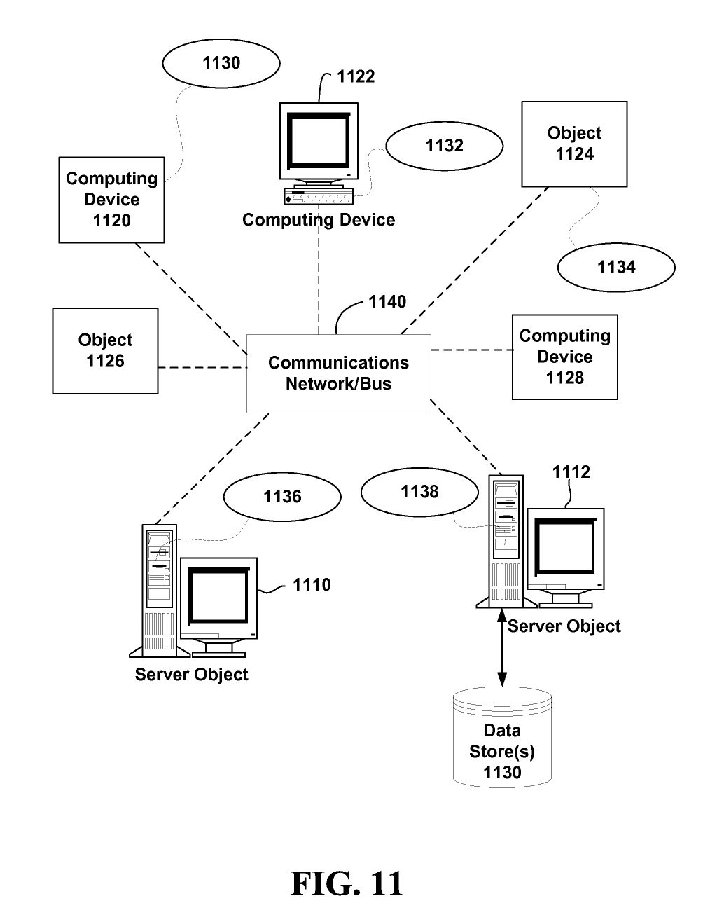

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that objects 1110, 1112, etc. and computing objects or devices 1120, 1122, 1124, 1126, 1128, etc. may comprise different devices, such as PDAs, audio/video devices, mobile phones, MP3 players, personal computers, laptops, etc.

Each object 1110, 1112, etc. and computing objects or devices 1120, 1122, 1124, 1126, 1128, etc. can communicate with one or more other objects 1110, 1112, etc. and computing objects or devices 1120, 1122, 1124, 1126, 1128, etc. by way of the communications network 1140, either directly or indirectly. Even though illustrated as a single element in FIG. 11, network 1140 may comprise other computing objects and computing devices that provide services to the system of FIG. 11, and/or may represent multiple interconnected networks, which are not shown. Each object 1110, 1112, etc. or 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the systems provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the various embodiments described herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 11, as a non-limiting example, computers 1120, 1122, 1124, 1126, 1128, etc. can be thought of as clients and computers 1110, 1112, etc. can be thought of as servers where servers 1110, 1112, etc. provide data services, such as receiving data from client computers 1120, 1122, 1124, 1126, 1128, etc., storing of data, processing of data, transmitting data to client computers 1120, 1122, 1124, 1126, 1128, etc., although any computer can be considered a client, a server, or both, depending on the circumstances. Any of these computing devices may be processing data to execute aspects described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing aspects described herein can be provided either alone, or distributed across multiple computing devices or objects.

In a network environment in which the communications network/bus 1140 is the Internet, for example, the servers 1110, 1112, etc. can be Web servers with which the clients 1120, 1122, 1124, 1126, 1128, etc. communicate via any of a number of known protocols, such as the hypertext transfer protocol (HTTP). Servers 1110, 1112, etc. may also serve as clients 1120, 1122, 1124, 1126, 1128, etc., as may be characteristic of a distributed computing environment.

### Exemplary Computing Device

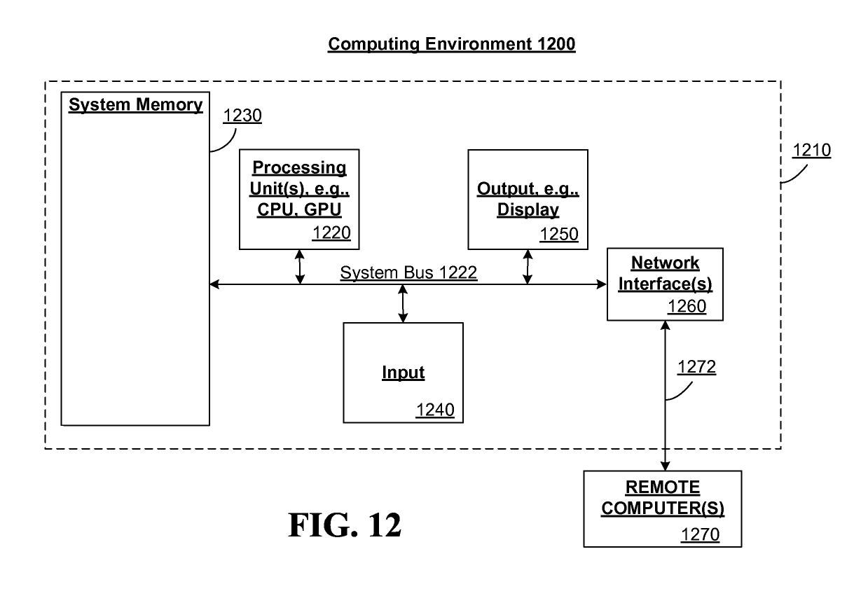

As mentioned, advantageously, the techniques described herein are implementable on any of a plurality of types of computing devices. It should be understood, therefore, that handheld, portable and other computing devices and computing objects of all kinds are contemplated for use in connection with the various embodiments. Accordingly, the below general purpose remote computer described below in FIG. 12 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 12 thus illustrates an example of a suitable computing system environment 1200 in which one or aspects of the embodiments described herein can be implemented, although as made clear above, the computing system environment 1200 is only one example of a suitable computing environment and is not intended to suggest any limitation as to scope of use or functionality. Neither should the computing environment 1200 be interpreted as having any dependency or requirement relating to any one or combination of components illustrated in the exemplary operating environment 1200.

With reference to FIG. 12, an exemplary device for implementing one or more embodiments includes a general purpose computing device in the form of a computer 1210. Components of computer 1210 may include, but are not limited to, a processing unit 1220, a system memory 1230, and a system bus 1222 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, memory 1230 may also include an operating system, application programs, other program modules, and program data.

A user can enter commands and information into the computer 1210 through input devices 1240. A monitor or other type of display device is also connected to the system bus 1222 via an interface, such as output interface 1250. In addition to a monitor, computers can also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1272, such local area network (LAN) or a wide area network (WAN), but may also include other networks/buses. Such networking environments are commonplace in homes, offices, enterprise-wide computer networks, intranets and the Internet.

Also, there are multiple ways to implement the same or similar functionality, e.g., an appropriate API, tool kit, driver code, operating system, control, standalone or downloadable software object, etc. which enables applications and services to use location-based campaign information as described herein. Thus, embodiments herein are contemplated from the standpoint of an API (or other software object), as well as from a software or hardware object that provides access to the location-based campaign objects. Accordingly, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method that facilitates flow design for multimodal communication applications, comprising:
employing a processor to execute computer executable instructions stored on a computer readable storage medium to implement a series of acts including:
receiving a user input;
generating a first application module to receive a first data via a first communication channel, the first application module generated based at least in part on the user input;
generating a second application module to receive a second data via a second communication channel disparate from the first communication channel, the second application module generated based at least in part on the user input; and
interchanging the first application module with the second application module within an interchangeable sequence of application modules based at least in part on the user input.

2. The method of claim 1 further comprising executing at least one of the first application module or the second application module.

3. The method of claim 1 further comprising generating at least one of the first application module or the second application module to generate an output based at least in part on a third data received from a third application module.

4. The method of claim 1 further comprising generating at least one of the first application module or the second application module to generate an output based at least in part on a third data corresponding to a user profile.

5. The method of claim 1 further comprising generating at least one of the first application module or the second application module to generate an output transmittable to any of a plurality of destinations, and selecting a particular destination from the plurality of destinations to transmit the output.

6. The method of claim 1 further comprising tracking metrics corresponding to an execution of at least one of the first application module or the second application module.

7. A computer-readable storage medium that facilitates flow design for multimodal communication applications, comprising:
computer-readable instructions, the computer-readable instructions including instructions that when executed by at least one processor cause the at least one processor to perform the following acts:
receiving a user input;
generating a first application module to receive a first data via a first communication channel, the first application module generated based at least in part on the user input;
generating a second application module to receive a second data via a second communication channel disparate from the first communication channel, the second application module generated based at least in part on the user input; and
executing an interchangeable sequence of application modules based at least in part on the user input, wherein the interchangeable sequence includes the first application module and the second application module.

8. The computer-readable storage medium of claim 7, wherein the computer-readable instructions further include instructions that when executed by the at least one processor cause the at least one processor to interchange the first application module and the second application module within the interchangeable sequence of application modules based at least in part on the user input.

9. The computer-readable storage medium of claim 7, wherein the computer-readable instructions further include instructions that when executed by the at least one processor cause the at least one processor to embed a logic operation within at least one of the first application module or the second application module based on the user input.

10. The computer-readable storage medium of claim 9, wherein the computer-readable instructions further include instructions that when executed by the at least one processor cause the at least one processor to execute the logic operation to select a particular destination from a plurality of potential destinations to transmit an output.

11. The computer-readable storage medium of claim 7, wherein the computer-readable instructions further include instructions that when executed by the at least one processor cause the at least one processor to track metrics corresponding to an execution of at least one of the first application module or the second application module.

12. The computer-readable storage medium of claim 7, wherein the computer-readable instructions further include instructions that when executed by the at least one processor cause the at least one processor to generate an output based at least in part on a third data corresponding to a user profile.

13. The computer-readable storage medium of claim 7, wherein the computer-readable instructions further include instructions that when executed by the at least one processor cause the at least one processor to select a particular algorithm from a plurality of algorithms to generate an output, wherein the particular algorithm is selected based on a position of at least one application module within the interchangeable sequence of application modules.

14. A system that facilitates flow design for multimodal communication applications, comprising:
a memory having computer executable components stored thereon; and
a processor communicatively coupled to the memory, the processor configured to execute the computer executable components, the computer executable components comprising:
a graphical user interface (GUI) component configured to receive a user input;
an application component configured to facilitate providing access to at least a first application module and a second application module based on the user input, wherein the first application module is configured to receive data via a first communication channel, and wherein the second application module is configured to receive data via a second communication channel disparate from the first communication channel; and
a sequence component configured to facilitate arranging an interchangeable sequence of application modules based on the user input, wherein the interchangeable sequence of application modules includes the first application module, and wherein the interchangeable sequence of application modules includes the second application module.

15. The system of claim 14 further comprising a communication component configured to establish a communication with a host device, wherein the communication component is configured to receive at least one output from the host device corresponding to an execution of at least one application module in the interchangeable sequence of application modules on the host device.

16. The system of claim 15, wherein the host device is configured to communicate with at least one external entity, and wherein the at least one output is based on an input received from the at least one external entity.

17. The system of claim 15, wherein the application component is configured to direct the host device to retrieve at least one of the first application module or the second application module from a storage location.

18. The system of claim 15, wherein the application component is configured to direct the host device to generate at least one of the first application module or the second application module.

19. The system of claim 15 further comprising a logic component configured to direct the host device to select a particular destination from a plurality of potential destinations to transmit the at least one output.

20. The system of claim 15 further comprising a metrics component configured to direct the host device to track metrics corresponding to the execution of the at least one application module.
